(19) United States
(12) Patent Application Publication
(10) Pub. No.: US 2011/0082329 A1
(43) Pub. Date: Apr. 7, 2011

(54) Modification of Sperm Motility and Its Storage Shelf Time

(76) Inventor: Istvan Szabo, Budapest (HU)

(21) Appl. No.: 12/922,563

(22) PCT Filed: Apr. 9, 2009
(86) PCT No.: PCT/HU2009/000031

§ 371 Date: Nov. 20, 2010

(30) Foreign Application Priority Data
Apr. 11, 2008 (HU) P800237

(51) Int. Cl. A61D 19/02; A01N 1/02; C01G 51/08; C01G 53/09

(52) U.S. Cl. 600/35; 435/2; 423/493

(57) ABSTRACT

The invention relates to a composition for increasing sperm motility at low metal ion concentration and/or decreasing sperm motility at high metal ion concentration, wherein said composition comprises one or more metal ion selected from Co²⁺ and Ni²⁺ or compounds thereof as an active ingredient either alone or in combination with a physiologically acceptable carrier and optionally auxiliary ingredients.

The invention includes the use of the above metal ions or compounds thereof for the preparation of a composition for increasing sperm motility in low concentration and decreasing sperm motility in high concentration, and the use of such compositions.

### BACKGROUND OF INVENTION

1. Field of the Invention

The invention relates to the use of certain metal ions for increasing and/or decreasing sperm motility. The invention could be used to increase sperm storage shelf time, as well as to support fertilization.

The invention includes compositions comprising the above metal ions, as well as the use thereof.

2. Background and Description of the Related Art

The successful fertilization of sperm cells, excluding genetic defects, depends on the number of sperms (quantity) and sperm motility (quality). The efficiency of fertilization mainly depends on sperm motility. The relative sperm motility could be improved by in vitro physical methods, such as washing, centrifugation, selective assortment by diffusion parameters and so on. Sperm motility could be improved by chemical agents too, for example bicarbonate anions and chelating agents (such as DL-penicillamine, 2,3-dimerkaptopropan-1-sulphonate and meso-2,3-dimerkapto-succinate) (Ralf R Henkel; Wolf-Bernhard Schill: “Sperm preparation for ART”, Reproductive Biology and Endocrinology 1:108 (2003).

It is well known that sperms could be preferably preserved either at physiological temperature or below. Generally, sperm cells could be preserved almost indefinitely by deep-freezing (e.g. storing them over liquid nitrogen or in temperature maintaining liquid nitrogen temperature) for unlimited time (G. N. Clarke et al.: Fertil. Sterile. 86, 721-722 (2006); Don P. Wolf et al. (ed): Assisted Fertilization and Nuclear Transfer in Animals, Humana Press, 1st ed., 2001; and EP 1 257 168). Exclusion goes for example to porcine (pig) sperm, which can not be stored successfully by deep-freezing.

Present state of the art preservation technical methods have the disadvantage that following deep-freezing, storage and thawing, sperm motility are depressed, therefore fertilization ability decreases significantly (M. R. Fernandez et al.: Reprod. Domest. Anim. 42(3), 305-311 (2007).

The present invention provides a solution for the above-mentioned disadvantages.

### DETAILED DESCRIPTION

It is publicly known from the literature that certain divalent cations, such as Co²⁺ and Ni²⁺ influence sperm motility. It is clear, that regarding cobalt (J. R. Bucher et al.: Fundam. Appl. Toxicol. 15(2), 357-372 (1990); G. P. Kumar et al.: Contraception 41(6), 633-639 (1990); N. G. Pedigo et al.: Reprod. Toxicol. 2(1), 45-53 (1988)) and nickel (K. Yokoi et al.: Biol. Trace Elem. Res. 93(1-3), 141-154 (2003); K. K. Dass et al.: Biol. Ttrace Elem. Res. 73(2), 175-180 (2000); R. Pandey et al.: Biometals 12(4), 339-346 (1999); Z. Bird et al.: J. Struct. Biol. 116(3), 418-428 (1996)) cations, according to the above cited publications, independently from the applied concentrations, only neutral—no effect on sperm motility—or negative—decreasing effect on sperm motility—effects were reported.

Effects increasing sperm motility by said ions are not known. Furthermore, according to above cited publications, the relationship between ion concentration and biological activity have not been investigated.

Surprisingly we have found that there is a specific relationship between the concentration of said ions and the biological activity, namely these ions decrease sperm motility in high concentration, while increase sperm motility in low concentration.

Therefore, the object of the present invention provides a composition for improving sperm motility in low metal ion concentration and/or decreasing sperm motility in high metal ion concentration, containing, as an active ingredient, one or more metal ion selected from the group consisting of Co²⁺ and Ni²⁺ or compounds thereof, either alone or in combination with a physiologically acceptable carrier and optionally auxiliary ingredients.

Furthermore, the present invention provides the use of one or more metal ion selected from the group consisting of Co²⁺ and Ni²⁺ or compounds thereof as an active ingredient for the preparation of a composition for improving sperm motility in low metal ion concentration and/or decreasing sperm motility in high metal ion concentration.

Furthermore, the present invention provides the use of one or more metal ion selected from the group consisting of Co²⁺ and Ni²⁺ or compounds thereof as an active ingredient either alone or as a formulated composition for the treatment of sperms to increase sperm motility in low metal ion concentration and/or decrease sperm motility in high metal ion concentration.

The invention is applicable in a broad way independently from the source of the sperms. According to a preferred embodiment of the invention, we apply the invention for the treatment of human sperms. According to another preferred embodiment of the invention, we apply the invention for the treatment of animal sperms. Accordingly, the treatment according to the invention could be successfully used on domestic and wild mammals, birds, amphibians, fish and insects. In particular for mammals, porcine, bovine, equine, ovine, caprine and leporine could be mentioned as example. In particular for birds, poultry, such as chicken, duck, goose and turkey could be mentioned as example. In particular for amphibians, frogs could be mentioned as example. In particular for fish, zebra fish (Brachidanio rerio) could be mentioned as example. In particular for insects, honey-bee (Apis mellifica) and carpenter bee could be mentioned as example. The invention is preferably applicable on endangered species, such as cheetah, in which case the artificial insemination is routinely used. The above-mentioned examples are non-limiting with respect to successfully applying the treatment to other animal species.

The invention is applicable in a broad way in every fields where decreasing or increasing of sperm motility is needed. Application examples include the improvement of natureal and artificial insemination, control of the breeding outcome in animal populations and improvement of the number of offspring originating from male animals having appropriate genetic properties, and in humans and animals for the treatment of male and female infertility, protection and prevention against toxic environmental and industrial agents having negative effects on sperm quality, protection and prevention against negative effects originating from diseases, protection and prevention against side effects of medications used to treat diseases, improvement of sperm storage time and contraception.

The essence of the invention is the use of one or more metal ion selected from the group consisting of Co²⁺ and Ni²⁺ or compounds thereof as an active ingredient either alone or as a formulated composition for the treatment of sperms for improving sperm motility in low metal ion concentration and/or decreasing sperm motility in high metal ion concentration. In a preferred embodiment, the invention provides the use of Co²⁺ metal ions or compounds thereof as an active ingredient, either alone or as a formulated composition. In another preferred embodiment, the invention provides the use of Ni²⁺ metal ions or compounds thereof as an active ingredient, either alone or as a formulated composition.

According to the invention, the sperms are contacted with the active ingredient, whereby a decrease of sperm motility is effected in high metal ion concentration and/or an increase of sperm motility is effected in low metal ion concentration.

The metal ions could be applied alone or by using their compounds. Examples of appropriate compounds include the appropriate inorganic or organic salts, such as halogens, sulphates, nitrates, phosphates, carbonates, bicarbonates and hydrates thereof, and salts formed with organic acids, such as acetic acid, citric acid, malic acid, tartaric acid and succinic acid salts. Preferred useful compounds include CoF₂, CoCl₂, CoBr₂, CoI₂, CoSO₄, Co(NO₃)₂, CO₃(PO₄)₂, CoCO₃, Co(HCO₃)₂, NiF₂, NiCl₂, NiBr₂, NiI₂, NiSO₄, Ni(NO₃)₂, Ni₃(PO₄)₂, NiCO₃, Ni(HCO₃)₂. Especially preferred useful compounds include CoCl₂, CO₃(PO₄)₂, CoCO₃, Co(HCO₃)₂, NiCl₂, Ni₃(PO₄)₂, NiCO₃, Ni(HCO₃)₂. Further examples of metal ion compounds include the appropriate complexes, such as diaminoethanetetraacetic acid (EDTA), ethylene glycol tetraacetic acid (EGTA), cyclodextrin and derivatives thereof, proteins, such as albumin, and amino acid complexes.

The metal ions useful according to the invention and compounds thereof are generally known (S. Y. Tyree et al.: Textbook of Inorganic Chemistry, Macmillan, 1961; Th. Moeller: Inorganic Chemistry: An Advanced Textbook, Wiley, 1952), and readily available commercially or could be prepared by generally known procedures.

As stated before, metal ions or compounds thereof could be used alone or in the form of a composition, which might contain, along with the active ingredient, physiologically acceptable carrier and optionally other auxiliary ingredients.

The product could be in forms of tablets, coated tablets, capsules, dragées, pills, granules, powders, aerosols, syrups, emulsions, suspensions, solutions, creams or jellies. The concentration of the active ingredient is 0.5-90 w/w %, preferably 10-70 w/w % with respect to the total mixture.

Carriers and/or auxiliary ingredients suitable for manufacturing the composition include water, organic solvents having no toxic effects e.g. paraffins, including crude oil by-products, vegetable oils, including peanut or sesame oil, alcohols, including ethanol and glycerol, glycols, including propylene-glycol and polyethylene-glycol, cyclodextrin and derivatives thereof, solid carriers, such as grounded natural earth ingrediets, e.g. kaolin, clay, talc and chalk, artificial inorganic powders, e.g. high dispersity silicic acid or other silicate compounds, saccharides, such as sucrose, lactose and glucose, emulsifiers, such as polyoxyethylene-fattyacidester, polyoxyethylene-fattyalcoholether, alkyl sulphonate, aryl sulphonate, dispersing agents e.g. lignin, sulphite liquor, methyl cellulose, starch, polyvinylpyrrolidine and glidants, e.g. magnesium stearate, talc, stearic acid and sodium lauryl sulphate.

The composition, as suitable for oral administration, might contain, apart from the above-listed carriers, additional ingredients, such as sodium citrate, calcium carbonate and dicalcium phosphate, together with other additives, such as starch, preferably potato starch, gelatin and similar substances. Additionally, gliding agents, such as magnesium stearate, sodium lauryl sulphate and talc may be used for tabletting. In the case of water-based suspension intended for oral administration, the active ingredients may be mixed with other flavoring and coloring ingredients in addition to the above-listed auxiliary ingredients.

For parenteral administration, a solution prepared with a fluid carrier is suitable.

For the preparation of the composition, a known method could be used, by mixing the active ingredients with the carrier and optionally the auxiliary ingredients, and by formulating the resulting mixture.

It is possible to incorporate the active ingredient alone or as a composition into a human or veterinarian insemination device, which could be used directly for insemination purposes. This could be achieved for example in a way that the insemination device directly contains the active ingredient alone or as a composition, or in an indirect way, when it is placed into the insemination device, for example in the form of a cartridge, before the insemination device is used.

According to the invention, the sperms are contacted with one or more metal ion or compound selected from the group consisting of Co²⁺ and Ni²⁺ or compounds thereof. This could be done by in vivo or in vitro treatment, accordingly.

For in vivo treatment, the metal ion or the compound thereof is administered either alone or in the form of an appropriate composition. Successful administration could be achieved by the standard way, preferably by oral or parenteral treatment in the case of the treatment of a male subject or by oral, parenteral or local administration, e.g. by placing a tampon, sponge, cream or jelly impregnated with the composition according to the invention into the vagina in the case of the treatment of a female subject. For in vivo treatment, the amount of metal ions administered is usually in the range of about 0.001 to about 15.0 mg/kg body weight per day, preferably in the range of about 0.015 to about 5.0 mg/kg body weight per day, with respect to the metal ion administered.

For in vitro treatment, (a) a solution containing the appropriate amount of the metal ion or the compound thereof or the composition comprising thereof is prepared, (b) an appropriate amount of the prepared solution is combined with the sperms or with the suspension containing sperms, (c) the mixture is incubated, (d) sperms having increased motility are used for insemination, or (e), after steps (b) or (c), the sperms having decreased motility are stored for later application, and (f) if desired, sperm motility could be increased again by decreasing the concentration by appropriate dilution before application, and the sperms are then utilized for fertilization.

In step (a), for solution preparation, water or organic solvents, having no toxic effect in the preferred concentration could be used, such as ethanol, glycerol, dimethyl-sulphoxide (DMSO), protein solutions and physiological saline or sugar solution. Preferably water, protein solutions, physiological saline solution, sugar solution or glycerin are used. With respect to metal ion concentration, the concentration of the solution is generally in the range of about 0.00005 to about 0.15 w/w %, more preferably from about 0.00012 to about 0.12 w/w %.

In step (b), the solution is added to sperms or suspension of sperms, wherein the concentration of the suspension is generally from about 10⁸ to about 10⁴ cell/ml, more preferably from about 10⁸ to about 10⁵ cell/ml, by reference to at least partially viable cells. The solution is applied in such a way that the final metal ion concentration reaches the range of about from 0.1 μmol/L to about 100 mmol/L, depending on the goal being increasing or decreasing the motility of the sperms. For increasing sperm motility, the metal ion concentration generally is in the range of about 0.1 μmol/L to about 1.0 mmol/L, preferably in the range of about 1.0 μmol/L to about 0.1 mmol/L. For decreasing sperm motility, the metal ion concentration generally is in the range of about 1.0 mmol/L-100 mmol/L, preferably in the range of about 10 mmol/L to about 100 mmol/L.

In step (c), the incubation generally is carried out at a temperature from about 4 to about 30° C., preferably from about 4 to about 37° C., generally for about 1 to about 60 minutes, preferably for about 5 to about 30 minutes.

In step (d), the insemination is carried out by using standard artificial insemination protocols (D. P. Wolf and M. Zelinsky-Wooten: “Assisted Fertilization and Nuclear Transfer in Animals (Contemporary Endocrinology)” Humana Press, 1. ed., 2001; S. Golombok et al.: “The European study of assisted reproduction families: the transition to adolescence” Human Reproduction 17(3), 830-840 (2002)).

In step (e), the storage time and temperature depends on the type of sperm, determined by donor sperm characteristics and on sperm quality, as well as on the concentration of the applied metal ion.

In step (f), the dilution is carried out by using any solvents described under step (a), to reach the above range of metal ion concentration between about 0.1 μmol/L and about 1.0 mmol/L, preferably between 0.1 μmol/L and about 0.1 mmol/L suitable for increasing sperm motility. Insemination or fertilization is then carried out as outlined in the description of step (d).

The said in vitro treatment could be performed on freshly collected sperms, wherein the above steps from (a) to (d) or from (a) to (f) steps are carried out immediately or within a short period of time following sperm collection. However, the in vitro treatment also could be performed on sperms stored for a short or for an extended period of time using a known storage method, after which the above steps from (a) to (d) are carried out. The storage of sperms could be achieved by using any known storage method, for example by deep-freezing (G. N. Clarke et al.: Fertil. Steril. 86, 721-722 (2006); Don P. Wolf et al. (ed): Assisted Fertilization and Nuclear Transfer in Animals, Humana Press, 1st ed., 2001; or EP 1 257 168).

As mentioned above, the invention provides metal ions for the modification of sperm motility. By contacting sperms with solutions containing high metal ion concentration, the motility decreases, enabling storage for a prolonged time period, then, following the storage period, by diluting the whole mixture the decreased metal ion concentration causes a stimulation, as opposed to the previous stage, whereby the increased motility facilitates the insemination or fertilization. By diluting sperms directly with solutions containing low concentration of metal ions, the motility increases, which facilitates insemination.

Furthermore, the invention could be utilized for contraception, since in sufficiently high concentration the active ingredients according to the invention will achieve a spermicidal effect. To this effect, the active ingredient should be applied generally in a metal ion concentration range between about 1.0 mmol/L and about 100 mmol/L, preferably between about 10 mmol/L and about 100 mmol/L.

The invention further could be utilized for restoration or improvement of motility in the case of sperms having depressed motility. In this embodiment, the negative effect on motility is reversed by applying the above active ingredients on sperms with decreased motility, resulting in the restoration of motility to the original level, or the motility further increases compared to the original level. In this context, reasons for depressed sperm motility include relevant health disorders, negative effects of toxic environmental or industrial agents, and negative effects related to storage conditions affecting sperm motility.

Examples of health disorders include genetic or congenital deficiencies or negative effects caused by illnesses or their consequences. Conditions that increase the temperature of testes can greatly reduce the number of sperm and the vigor of sperm movement and can increase the number of abnormal sperm. Temperature may be increased by exposure to excessive heat, disorders that produce a prolonged fever, undescended testes and varicose veins in the testes (variocele).

Certain hormonal or genetic disorders may interfere with sperm production. Hormonal disorders include hyperprolactinemia, hypothyroidism, hypogonadism and disorders of the adrenal gland (which produces testosterone and other hormones) or the pituitary gland (which regulates the production of testosterone). Genetic disorders include for example the abnormality of the sex chromosomes, as occurs in Klinefelter syndrome.

Other diseases influencing sperm production include mumps that affects the testes (mumps orchitis) and injury to the testes.

Sperm production is further influenced by the negative effects of the medical and non-medical drugs used for the treatment of diseases. Such drugs include for example androgens, such as testosterone, aspirin, when taken for a long time, chlorambucil, cimetidine, colchicine, corticosteroids, such as prednisone, cotrimoxazole, cyclophosphamide, drugs against malaria, estrogens used to treat the prostata, marijuana, medroxyprogesterone, methotrexate, monoamine oxidase inhibitors (MAOs), nicotine, nitrofurantoin, opioids, spironolactone and sulphasalazine. Similarly, the use of anabolic steroids may affect hormone levels and thus also interferes with sperm production (Merck Manual of Medical Information—Second Home Edition; editor-in-chief: Mark H. Beers; Merck Research Laboratories; 2003).

Toxic environmental and industrial agents include for example certain metal ions, e.g. Hg²⁺ and Cd²⁺ (I. Szabó et al.: The Toxicologist 48, 383 (1999)), and polychlorinated biphenyl compounds (PCBs), alkyl phenols, e.g. 4-nonylphenol and bisphenol, and organic compounds containing fluor, e.g. perfluorooctane-octanoate and perfluorooctane-sulphonate (R. Hauser: Semin. Reprod. Med. 24, 156-167 (2006)).

Decreased sperm motility caused by storage conditions might be exemplified by the applied low temperature of deep-freezing.

It is emphasized that the present invention could also be successfully used in cases where not, or not just motility decrease takes place but the number of sperms is modified. Lower sperm count in combination with increased motility could achieve similar or even higher fertilization or insemination rate compared to average sperm count combined with average motility.

The invention could also be used, based on a sufficient decreasing effect on motility, for increasing sperm storage shelf time, and to provide storage in the case of sperms, such as porcine sperms, where storage time is none or limited, e.g. storage time is short and conditions are difficult to achieve. In addition, spermicidal effect could be achieved using sufficiently high metal ion concentrations, therefore the invention may be used as a contraceptive. Furthermore, the present invention could also be used, based on the increasing effect on motility, for the improvement of fertilization either upon natural or artificial insemination. It is further possible to combine the sperm motility decreasing and sperm motility increasing effects, whereby providing improved sperm storage time by application of high metal ion concentrations, followed by a dilution step after storage to decrease the metal ion concentration, which facilitates fertilization by increased sperm motility.

The invention could be preferably used in combination with known methodologies and with known substances used for increasing sperm motility and/or improving sperm storage time, including e.g. the use of flavonoid derivatives, application of low or high pressure, or sorting of sperms using physical methods.

As mentioned above, the invention may be used to increase the storage time for the preservation of sperms by inducing decreased sperm motility in the presence of high metal ion concentration. In addition, the invention may be used to improve the fertilization capability of sperms by inducing increased sperm motility in the presence of low metal ion concentrations, i.e. to ensure fertilization of the ovum. Fertilization or insemination of the ovum could be achieved naturally, e.g. in vivo, or using assisted methods, e.g. in vitro insemination or fertilization. In vitro (artificial) insemination could be achieved using naturally occurring or appropriately stored ovum cells, fertilized with naturally occurring fresh or appropriately preserved sperms, including sperms treated with metal ions according to the present invention, having increased motility. During fertilization or insemination, known methods are used including but not limited to traditional methods (H. Schatten, G. M. Constantinescu: Comparative Reproductive Biology, Blackwell Publishing Limited, 2007 and J. R. Michell, G. A. Doak, H. A. Herman: The artificial insemination and embryo transfer of dairy and beef cattle (Including Information Pertaining to Goats, Sheep, Horses, Swine and other Animals), Upper Saddle River, N.J., Pearson/Prentice Hall, 2004). Following fertilization or insemination, the fertilized or inseminated ovum or ova develops into embryo or embryos in the usual way.

Accordingly, the invention provides an ovum or ova, which is fertilized or inseminated by sperms treated with one or more metal ion selected from the group consisting of Co²⁺ and Ni²⁺ or compounds thereof as an active ingredient either alone or as a formulated composition.

The present invention will be further illustrated by the following examples.

### Example 1

Sperms originating from ripe sea urchins (Lytechinus pictus) showing genetic and functional similarity to human and animal sperms are used (R. Felix: Reproduction 129, 251-262 (2005).

Animals were washed by sequential immersion into 100 ml cold (approximately 5° C.) sperm storage buffer (SSB) pH 6.0. Used SSB composition: 50 mmol/L KCl, 5.0 mmol/L N-tris(hydroxymethyl)methyl-3-aminopropanesulphonic acid (TAPS), 425 mmol/L NaCl, 27 mmol/L MgCl₂, 29 mmol/L MgSO₄, 10 mmol/L CaCl₂ and 2.4 mmol/L NaHCO₃. Shedding of gametes was induced by intracoelomic injection of 2.0 ml cold 0.5 mol/L KCl through several sites on the peristomial membrane of the oral side. Sperm were collected by inverting male sea urchins over beakers containing approximately 100 ml cold MES sperm storage buffer (MSSB) pH 6.0. Used MSSB composition: 50 mmol/L KCl, 5.0 mM 2-[N-morpholino]ethanesulphonic acid (MES), 5.0 mmol/L TAPS, 425 mmol/L NaCl, 27 mmol/L MgCl₂, 29 mmol/L MgSO₄, 10 mmol/L CaCl₂ and 2.4 mmol/L NaHCO₃. A pool of sperm from several animals was made to minimize individual variations. Sperms were incubated in room temperature for 20 min. in 0.1-10 ml fractions diluted with 0.1-1000 ml activation buffer (ASW) pH 8.3. ASW composition: 50 mmol/L KCl, 5.0 mmol/L TAPS, 425 mmol/L NaCl, 27 mmol/L MgCl₂, 29 mmol/L MgSO₄, 10 mmol/L CaCl₂, 2.4 mmol/L NaHCO₃ and 1.0 mg/ml bovine serum albumin (BSA). The activation buffer contains the appropriate metal ions in a given concentration. Control experiments were carried out by transferring sperm into activation buffer do not containing metal ions. Metal ions were used as Cl⁻ salts. Video microscopy was performed at room temperature (22° C.) using a Nikon Diaphot inverted microscope with 20× BM phase objective and 1× video adapter connected to a Dage CCD72 camera. For the determination of sperm motility, sperm suspensions are diluted with activation buffer in a way that the viewing field shows 30-40 sperm cells and the suspension is placed into a motility-counting chamber. The video signal was sent via a video time clock to a Panasonic VHS video recorder. Motility was recorded on multiple viewing fields for 15 sec per field until the recorded total sperm number reached 400. Video tapes were analyzed using CellTrack system. Measurements were carried out in triplicates. Sperm motility is expressed in %, where control values represent 100% (Bracho et al.: “A Method for Preparation, Storage and Activation of Large Populations of Immotile Sea Urchin Sperm”, BBRC 237, 59-62 (1997)).

### Example 2

Sperms originating from ejaculates (2.0-5.0 ml) of healthy donors are diluted with 2.0-1000 ml cold MSSB buffer following liquidification and homogenized without modification of motility. From this point, sample handling and motility measurement is carried out as described in example#1.

### Results

Measurements are carried out using CASA (Computer Assisted Sperm Analysis) method within 12 hours following sperm collection or ejaculation. Metal ion concentrations and results are given in the following table.

| | motility (%) | | | | | |
|---|---|---|---|---|---|---|
| | | 1 μmol/ | 10 μmol/ | 100 μmol/ | 1 mmol/ | 10 mmol/ |
| sperm | control | L Co²⁺ | L Co²⁺ | L Co²⁺ | L Co²⁺ | L Co²⁺ |
| sea | 100 | 108.6 | 118.2 | 127.5 | 101.1 | 92.9 |
| urchin | | | | | | |
| human | 100 | 106.2 | 112.7 | 122.5 | 98.2 | 91.0 |

| | motility (%) | | | | | |
|---|---|---|---|---|---|---|
| | | 1 μmol/ | 10 μmol/ | 100 μmol/ | 1 mmol/ | 10 mmol/ |
| sperm | control | L Ni²⁺ | L Ni²⁺ | L Ni²⁺ | L Ni²⁺ | L Ni²⁺ |
| sea | 100 | 111.4 | 127.3 | 132.0 | 98.6 | 85.2 |
| urchin | | | | | | |
| human | 100 | 105.7 | 126.9 | 129.5 | 93.2 | 88.9 |

| | motility (%) | | |
|---|---|---|---|
| | | 16 μmol/L | 16 μmol/L Zn²⁺ + |
| sperm | control | Zn²⁺ | 10 μmol/L Ni²⁺ |
| sea urchin | 64.3 | 51.0 | 65.7 |

| | motility (%) | | |
|---|---|---|---|
| | | 3.5 μmol/L | 3.5 μmol/L Cd²⁺ + |
| sperm | control | Cd²⁺ | 10 μmol/L Co²⁺ |
| sea urchin | 64.0 | 49.1 | 64.9 |

### Example 3

a) Preparations of sea urchin sperm are produced as described in example 1. Motility measurements are carried out in predetermined time points as described in example#1 starting from time point 0. The activation buffer at time point 0 is supplemented with 20 mmol/L Ni²⁺ as NiCl₂. After 4 hours, sperm suspensions are diluted 100-fold with activation buffer, achieving 200 μmol/L final Ni²⁺ concentration. Measurements of motility are carried out further. Sperm motility is expressed in %, where control values at time point 0 represent 100%. Results are given in the table below.

Results clearly indicate that high metal ion concentration decreases sperm motility. Applying a simple dilution step, metal ion concentration decreases, achieving motility recovery and even further increase in motility.

| | time (hour:minute) | | | | | | | | | | |
|---|---|---|---|---|---|---|---|---|---|---|---|
| | 0:00 | 0:20 | 1:00 | 2:00 | 3:00 | 4:00 | 4:20 | 5:00 | 6:00 | 7:00 | 8:00 |
| motility (%) | 100 | 99.0 | 85.7 | 86.8 | 81.6 | 76.3 | 102.6 | 119.0 | 123.5 | 123.0 | 120.6 |

b) Preparations of sea urchin sperm are produced as described in example 1. Motility measurements are carried out in predetermined time points as described in example#1 starting from time point O, Sperm motility is expressed in %, where control values at time point 0 represent 100%.

Results clearly indicate that sperm motility decreases during storage, thus fertilization or insemination capability also decreases.

| | Time (hour:minute) | | | | | | | | | | |
|---|---|---|---|---|---|---|---|---|---|---|---|
| | 0:00 | 0:20 | 1:00 | 2:00 | 3:00 | 4:00 | 4:20 | 5:00 | 6:00 | 7:00 | 8:00 |
| motility (%) | 100 | 99.0 | 92.4 | 88.1 | 81.8 | 80.9 | 82.3 | 80.4 | 76.0 | 78.6 | 72.9 |

1. Composition for decreasing sperm motility at high metal ion concentration, comprising one or more metal ion selected from Co²⁺ and Ni²⁺ or compounds thereof as an active ingredient, either alone or in combination with a physiologically acceptable carrier and optionally auxiliary ingredients.

2. The composition according to claim 1, comprising the active ingredient in an amount to be administered within the dose range between 1.0 mmol/L and 100 mmol/L to decrease sperm motility.

3. The composition according to claim 15, comprising the active ingredient in an amount to be administered within the dose range between 0.1 μmol/L and 1.0 mmol/L to increase sperm motility.

4. Use of one or more metal ion selected from the group consisting of Co²⁺ and Ni²⁺ or compounds thereof as an active ingredient for the preparation of a composition for decreasing sperm motility at high metal ion concentration.

5. The use according to claim 4, wherein the active ingredient is used in an amount to be administered within the dose range between 1.0 mmol/L and 100 mmol/L to decrease sperm motility.

6. The use according to claim 16, wherein the active ingredient is used in an amount to be administered within the dose range between 0.1 μmol/L and 1.0 mmol/L to increase sperm motility.

7. Use of one or more metal ion selected from the group consisting of Co²⁺ and Ni²⁺ or compounds thereof as an active ingredient either alone or as a formulated composition for the treatment of sperms for decreasing sperm motility at high metal ion concentration.

8. The use according to claim 7, wherein the active ingredient is used in a dose range between 1.0 mmol/L and 100 mmol/L to decrease sperm motility.

9. The use according to claim 17, wherein the active ingredient is used in a dose range between 0.1 μmol/L and 1.0 mmol/L to increase sperm motility.

10. Use of one or more metal ion selected from the group consisting of Co²⁺ and Ni²⁺ or compounds thereof as an active ingredient either alone or as a formulated composition for the treatment of sperms having decreased motility to reverse, restore or further increase the motility thereof.

11. The use according to claim 10, for the treatment of sperms having decreased motility caused by health disorders.

12. The use according to claim 10, for the treatment of sperms having decreased motility caused by environmental and industrial toxic agents.

13. The use according to claim 10, for the treatment of sperms having decreased motility induced by storage conditions.

14. Ovum of an animal, which is fertilized or inseminated by the use of sperms treated with one or more metal ion selected from the group consisting of Co²⁺ and Ni²⁺ or compounds thereof as an active ingredient either alone or as a formulated composition.
